(19) United States
(12) Patent Application Publication
(10) Pub. No.: US 2013/0287672 A1
(43) Pub. Date: Oct. 31, 2013

(54) Method for Increasing Efficiency in Mineral Carbonation Using Furnace Slag as Industrial Byproduct

(71) Applicant: Korea Institute of Geoscience and Mineral Resources, Daejeon (KR)

(72) Inventors: Soo Chun Chae, Seoul (KR); Young Nam Jang, Daejeon (KR); Kyung Won Ryu, Daejeon (KR); Seung Woo Lee, Daejeon (KR); Kyung Sun Song, Daejeon (KR); Chi Wan Jeon, Daejeon (KR); Myung Gyu Lee, Daejeon (KR); Jun Hwan Bang, Daejeon (KR)

(21) Appl. No.: 13/661,190

(22) Filed: Oct. 26, 2012

(30) Foreign Application Priority Data
Oct. 27, 2011 (KR) 10-2011-0110252

(51) Int. Cl. C01F 11/18

(52) U.S. Cl. CPC C01F 11/18
USPC 423/431

(57) ABSTRACT

Provided is a method for fixing carbon dioxide, the method includding: pulverizing furnace slag; mixing water and the furnace slag such that the furnace slag is present in a concentration of 5˜15 parts by weight based on 100 parts by weight of water; adding NaOH to the mixture; and supplying carbon dioxide to the decomposed mixture, and then carrying out a hydrothermal reaction, so that carbon dioxide can be stably fixed; the treatment of the furnace slag can lead to ecofriendly effects; and the use of the furnace slag can lead to production of carbonate minerals as the final product.

### CROSS-REFERENCE TO RELATED APPLICATIONS

This application claims priority under 35 U.S.C. §119 to Korean Patent Application No. 10-2011-0110252, filed on Oct. 27, 2011, in the Korean Intellectual Property Office, the disclosure of which is incorporated herein by reference in its entirety.

### TECHNICAL FIELD

The following disclosure relates to a method for fixing carbon dioxide by using furnace slag as an industrial byproduct, and then improving the grade of calcium carbonate that is generated.

### BACKGROUND

Based on the “Kyoto Protocol”, which is an international convention represented as a countermeasure against global warming, the countries participating in the convention should reduce emission amounts of six kinds of greenhouse gases including carbon dioxide by 5.2% as compared with those in the year of 1990. Therefore, a method for carbonation of various kinds of minerals by fixing greenhouse gas, in particular, CO₂ gas as a component of a mineral structure has been devised by advanced countries. This method was proposed by Seifritz in 1990, and first, natural rocks, such as basalt, and silicate minerals, such as olivine, serpentine and wollastonite were targets for the method, and after, the research for the method has widened to various kinds of industrial byproducts or wastes derived industrial activities. The mineral carbonation method is largely classified into a direct method (mineral carbonation occurring in a single process) and an indirect method (carbonation after previous extraction of Ca or Mg from mineral). In current, studies using the direct method and the indirect method with respect to various base materials have been actively conducted in Holland, and carbonation reaction studies on waste cements/concrete as industrial byproducts have been mainly conducted in Japan. In USA, the “DOE Mineral Carbonation Study Group” was organized by the Department of Energy in 1998, and thus institutes such as the Albany Research Center, Arizona State University, Los Alamos National Laboratory, National Energy Technology Laboratory, and Science Applications International Corp., started to conduct joint researches. In 2005, mineral carbonation was included as one branch of IPCC special reports related with collection and storage of carbon dioxide. Korean Patent Laid-Open Publication No. 2011-0061558 (Patent Document 1) discloses a method for carbonation of metal oxide into a solid material by using magnesium silicate hydroxide minerals.

The furnace slag used in the present invention is a material generated in a steelmaking industry. About 8.3 million tons of furnace slag is generated each year and contains about 44% of CaO, which is a main element of mineral carbonation. It is thought that about 2.90 million tons of CO₂ is reduced and about 6.60 million tons of carbonate mineral as a product thereof is produced each year, when a mineral carbonation reaction using the furnace slag as a base material is successfully conducted. As such, in addition to an effect of reducing CO₂, an additive effect of securing carbonate mineral resources as byproducts may be anticipated.

This method of fixing carbon dioxide using the furnace slag, which is a byproduct of the steelmaking industry, is disclosed in Korean Patent No. 10-0891551 (Patent Document 2). However, anhydrite (CaSO₄), which is in one of the crystalline phases of the furnace slag, is still present even after it is subjected to a carbonation procedure.

### RELATED ART DOCUMENTS

### Patent Documents

(Patent Document 1) Korean Patent Laid-Open Publication No. 2011-0061558
(Patent Document 2) Korean Patent No. 10-0891551

### SUMMARY

Various methods of fixing carbon dioxide from furnace slag were proposed from the related art, but anhydrite (CaSO₄), which is one of the crystalline phases of the furnace slag, is still present even after it is subjected to a carbonation procedure. This anhydrite contains CaO, which is main oxide of a carbonation reaction, which may cause carbonation efficiency of CaO to be lowered to about 60%. An embodiment of the present invention is directed to providing a method for increasing carbonation efficiency by completely decomposing CaO of anhydrite and suppressing re-precipitation of anhydrite even after a carbonation reaction.

Also, an embodiment of the present invention is directed to providing a method for manufacturing carbonate mineral, which is a geologically ecofriendly material, while achieving CO₂ reduction effect, by changing CO₂ gas, which is a main cause of climate change and attracts global attention, into stable-state carbonate minerals.

In one general aspect, there is provided a method for fixing carbon dioxide, the method includding:

a) pulverizing furnace slag (110);

b) mixing water and the furnace slag such that the furnace slag is present in a concentration of 5˜15 parts by weight based on 100 parts by weight of water (120);

c) adding NaOH to the mixture of the step b) (130); and

d) supplying carbon dioxide to the decomposed mixture of the step c), and then carrying out a hydrothermal reaction (140).

Here, in the step a), the furnace slag may be pulverized into 150-500 mesh.

Here, in the step c), NaOH may be inputted in a weight ratio of 1 mol of SO₃: 2˜4 mol of NaOH so as to generate sodium sulfate (Na₂SO₄) or Burkeite (Na₆CO₃(SO₄)₂), which is a residual salt in the step d), to thereby suppress re-precipitation of anhydrite (CaSO₄) contained in the furnace slag even after the hydrothermal reaction.

The method may further include, after the step d), e) removing the residual salt to improve grade of CaCO₃.

Here, the removing of the residual salt may be conducted by water washing.

Here, in the step d), the carbon dioxide may be supplied such that partial pressure of carbon dioxide within a reactor into which the mixture of the step c) is inputted becomes 10˜30 bar.

The hydrothermal reaction of the step d) may be conducted at 150˜3000° C., and the hydrothermal reaction of the step d) may be conducted while stirring is performed at a rotational speed of 1200˜1700 rpm.

Here, when, in the step e), the removing of the residual salt is conducted by water washing, filtering and drying may be further conducted, and the temperature for drying may be 80˜100° C.

Hereinafter, the present invention will be described in more detail with reference to the accompanying drawings. FIG. 1 is a schematic view explaining a method for fixing carbon dioxide according to the present invention.

The present invention provides a method for fixing carbon dioxide, the method including:

a) pulverizing furnace slag (110);

b) mixing water and the furnace slag such that the furnace slag is present in a concentration of 5-15 parts by weight based on 100 parts by weight of water (120);

c) adding NaOH to the mixture of the step b) (130); and

d) supplying carbon dioxide to the decomposed mixture of the step c), and then carrying out a hydrothermal reaction (140).

In the step a), the furnace slag is preferably pulverized into 150˜500 mesh. In the above pulverizing range, that is, the furnace slag pulverized into 150 mesh or greater is easily treated and the furnace slag pulverized into 500 mesh or smaller has an increased surface area, to thereby increase a contact area with carbon dioxide and improve effect in the hydrothermal reaction.

In the step b), the amount of furnace slag based on 100 parts by weight of water is largely limited, but may be appropriately 5˜15 parts by weight. If the amount of furnace slag is below 5 parts by weight, the carbonation rate may not be problematic but efficiency in cost is problematic. If the amount of furnace slag is above 15 parts by weight, the concentration of furnace slag is increased, and thus dispersibility of the furnace slag and the surface area thereof are rather reduced, resulting in lowering the carbonation rate.

Anhydrite (CaSO₄) is present in an aqueous solution in an ion type such as Ca²⁺ and SO₄²⁻.

In the step c), NaOH is added to the mixture (130). At the time of the carbonation reaction through the hydrothermal reaction of the step d), NaOH has an important function of suppressing re-precipitation, which is caused by recombination of Ca²⁺ and SO₄²⁻ of anhydrite (CaSO₄) even after the hydrothermal reaction.

Here, NaOH may be preferably inputted in a weight ratio of 1 mol of SO₃: 2 mol or higher of NaOH so as to generate sodium sulfate (Na₂SO₄) or Burkeite (Na₆CO₃(SO₄)₂), particularly, sodium sulfate (Na₂SO₄), in order to prevent re-precipitation of anhydrite after the hydrothermal reaction.

More preferably, NaOH is inputted in a weight ratio of 1 mole of SO₃: 2-4 mol of NaOH.

For this reason, the anhydrite is not re-precipitated after the hydrothermal reaction and Ca²⁺ participates in mineral carbonation to be a component of CaCO₃, to thereby improve the efficiency in CaO carbonation.

More specifically, in the present invention, in consideration of the content of SO₃ contained in the furnace slag, NaOH is inputted in a weight ratio of 1 mol of SO₃: 2˜4 mol of NaOH so as to generate sodium sulfate (Na₂SO₄) or Burkeite (Na₆CO₃(SO₄)₂), particularly, sodium sulfate (Na₂SO₄), which is a residual salt, in the hydrothermal reaction stage, so that at the time of the carbonation reaction, anhydrite contained in the furnace slag is completely dissociated into Ca²⁺ and SO₄²⁻, thereby suppressing re-precipitation. For this reason, the anhydrite, which is in one of the crystalline phases of the furnace slag, is completely associated into Ca²⁺ and SO₄²⁻, to generate sodium sulfate (Na₂SO₄) or Burkeite (Na₆CO₃(SO₄)₂), so that re-precipitation of the anhydrite can be suppressed even after the carbonation reaction and the carbonation efficiency can be remarkably improved. In addition, sodium sulfate (Na₂SO₄) or Burkeite (Na₆CO₃(SO₄)₂), which is in a middle phase of a decomposition reaction, is soluble in water, and thus completely removed by several times of washing, thereby contributing to improvement in efficiency in a mineral carbonation reaction.

According to an embodiment of the present invention, it can be confirmed that particularly when 0.2 g or more of NaOH per 20 g of furnace slag is added, the carbonation rate of CaO is very efficacious.

According to an embodiment of the present invention, the SO₄²⁻ ion dissociated from the anhydrite by addition of NaOH reacts with NaOH, to thereby generate sodium sulfate (Na₂SO₄) or Burkeite (Na₆CO₃(SO₄)₂), and the dissociated Ca²⁺ ion reacts with CO₂ to thereby generate CaCO₃. In addition, sodium sulfate (Na₂SO₄) and Burkeite (Na₆CO₃(SO₄)₂) are all soluble in water, and thus completely removed by several times of washing, thereby contributing to improvement in efficiency in a mineral carbonation reaction.

At the time of the hydrothermal reaction of the step d), carbon dioxide is preferably supplied such that the partial pressure of carbon dioxide within a closed reactor into which the mixture of the step c) is inputted becomes 10˜30 bar. If the partial pressure of carbon dioxide is below 10 bar, CaO contained in the furnace slag does not participate in carbonation, and thus may remain unreacted. If above 30 bar, this may be uneconomical.

The hydrothermal reaction of the step d) is preferably conducted at 150˜300° C. If the hydrothermal reaction is conducted at a temperature of below 150° C., efficiency in the carbonation reaction may be reduced. If above 300° C., this may be uneconomical and other phases may be generated.

In addition, at the time of the hydrothermal reaction of the step d), stirring is preferably conducted at a rotational speed of 1200˜1700 rpm in the reactor. Advantageously, this high-speed stirring improves reactivity of carbonation.

Further, the method for fixing carbon dioxide of the present invention may further include, after the step d), e) removing residual salts to improve grade of CaCO₃ (150).

The removing of the residual salts in the step e) is performed through washing with water.

In this case, filtering, washing, and drying may be further included, and at the time of drying, the drying temperature is preferably 80˜100° C.

The removal of the residual salts can improve the grade of CaCO₃.

### BRIEF DESCRIPTION OF THE DRAWINGS

FIG. 1 is a schematic view explaining a method for fixing carbon dioxide according to the present invention;

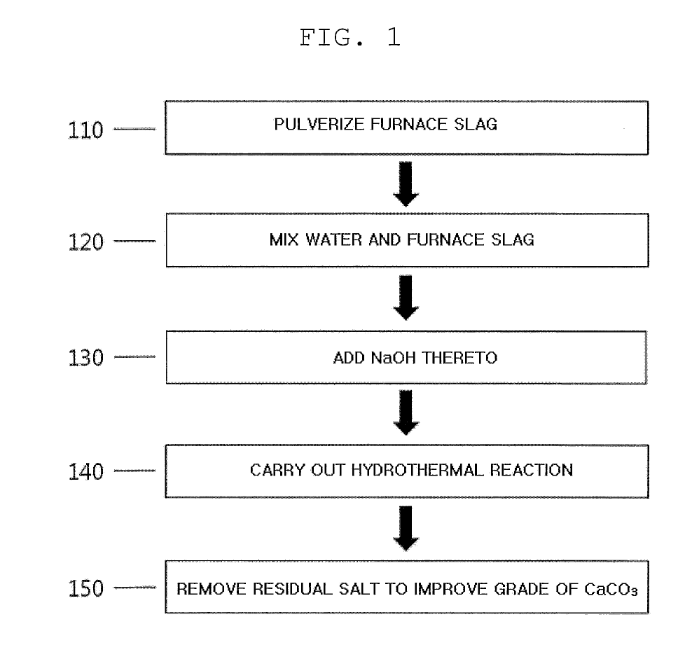

FIG. 2 shows XRD analysis results of Comparative Example 1 and Examples 1 and 2;

FIG. 3 shows XRD analysis results of Comparative Example 2 and Examples 3 and 4; and

FIG. 4 shows XRD analysis results of Comparative Example 3 and Examples 5 to 7.

### DETAILED DESCRIPTION OF EMBODIMENTS

Hereinafter, the present invention will be in detail described by examples and comparative examples, but the present invention is not limited to the following examples.

Table 1 shows data about the ideal content of CaCO₃, mathematically anticipated, when a total content of CaO contained in the furnace slag is converted into CaCO₃. This ideal content is a criterion for measuring carbonation efficiency and the content of carbonate mineral at the time of carbon analysis for a sample obtained from each experiment.

Among components of the furnace slag, which is an initial material, the content of CaO is about 44 wt. %. Assuming that the all of CaO reacts with CO₂, since the mass ratio of CaO to CO₂ is 56:44 in CaCO₃, the content of CO₂ is 34.6 wt. % as compared with the content of CaO (44 wt. %). When the content of CO₂ is added to components of the furnace slag and the components of the furnace slag are calculated in percentage terms, CaO is 32.73 wt. % and CO₂ is 25.72 wt. %, and thus, the content of CaCO₃ in a material after the carbonation reaction is 58.45 wt. % (hereinafter, described as “ideal component ratio of CaCO₃”) (Table 1). Therefore, based on this, the content of CaCO₃ is calculated as expressed in the following equation, which is divided by the “ideal content of CaCO₃” and then multiplied by 100. The calculated value is the content of CaO which participates in carbonation in the total content of CaO in the furnace slag, that is, the carbonation rate of CaO.

CaCO₃(wt.%)=C(wt.%)×3.6641×2.2743

Carbonation rate of CaO(%)=CaCO₃(wt. %)/58.45(wt. %)×100(%)

Here, 3.6641 is a transformation coefficient from C (content of C obtained from carbon analysis, wt. %) into CO₂, and 2.2743 is a transformation coefficient from CO₂ to CaCO₃.

TABLE 1

| | | | Ideal Content | |
|---|---|---|---|---|
| | Content Ratio | Normal | Content Ratio | Normal |
| Oxides | (wt. %) | (wt. %) | (wt. %) | (wt. %) |
| SiO₂ | 30.70 | 30.67 | 30.67 | 22.79 |
| TiO₂ | 0.64 | 0.64 | 0.64 | 0.48 |
| Al₂O₃ | 13.90 | 13.89 | 13.89 | 10.32 |
| Fe₂O₃ | 0.44 | 0.44 | 0.44 | 0.33 |
| FeO | 0.17 | 0.17 | 0.17 | 0.13 |
| MnO | 0.19 | 0.19 | 0.19 | 0.14 |
| MgO | 3.90 | 3.90 | 3.90 | 2.89 |
| Na₂O | 0.47 | 0.47 | 0.47 | 0.35 |
| K₂O | 0.49 | 0.49 | 0.49 | 0.36 |
| P₂O₅ | 0.01 | 0.01 | 0.01 | 0.01 |
| SO₃ | 5.07 | 5.06 | 5.06 | 3.76 |
| CaO | 44.10 | 44.06 | 44.06 | 32.73 |
| CO₂ | — | — | 34.62 | 25.72 |
| Total | 100.08 | 100.00 | 134.61 | 100.00 |

| | |
|---|---|
| CaCO₃ | 58.45 |

### Examples 1 and 2

Furnace slag was pulverized, and then 150˜200 mesh of furnish slag was selected. The selected furnace slag was mixed with water such that 20 g of furnace slag was present based on 200 g of water. Then, NaOH was added to the mixture in an amount of 1.013 g (Example 1) or 2.026 g (Example 2). The content of NaOH added was calculated from the weight ratio of 1 mol of SO₃: 2-4 mol of NaOH to generate sodium sulfate (Na₂SO₄), in consideration of the content of SO₃ contained in 20 g of the furnace slag. CO₂ gas was inputted into a closed reaction container having the mixture therein such that the partial pressure of CO₂ was 10 bar, and then the reaction was allowed to proceed at 150° C. for 6 hours while stirring was conducted at a rotational speed of 1500 rpm. The resultant material obtained after the foregoing hydrothermal reaction was filtered, and then subjected to several times of washing to remove residual salts, followed by drying at 90° C., thereby obtaining a product.

### Examples 3 and 4

Furnace slag was pulverized, and then 150˜200 mesh of furnish slag was selected. The selected furnace slag was mixed with water such that 20 g of furnace slag was present based on 200 g of water. Then, NaOH was added to the mixture in an amount of 1.013 g (Example 3) or 2.026 g (Example 4). The content of NaOH added was calculated from the weight ratio of 1 mol of SO₃: 2˜4 mol of NaOH to generate sodium sulfate (Na₂SO₄), in consideration of the content of SO₃ contained in 20 g of the furnace slag. CO₂ gas was inputted into a closed reaction container having the mixture therein such that partial pressure of CO₂ was 10 bar, and then the reaction was allowed to proceed at 200° C. for 6 hours while stirring was conducted at a rotational speed of 1500 rpm. The resultant material obtained after the foregoing hydrothermal reaction was filtered, and then subjected to several times of washing to remove residual salts, followed by drying at 90° C., thereby obtaining a product.

### Examples 5 to 7

Furnace slag was pulverized, and then 150-200 mesh of furnish slag was selected. The selected furnace slag was mixed with water such that 20 g of furnace slag was present based on 200 g of water. Then, NaOH was added to the mixture in an amount of 0.64 g (Example 5), 1.013 g (Example 6), or 2.026 g (Example 7). The content of NaOH added was calculated from the weight ratio of 1 mol of SO₃: 2-4 mol of NaOH to generate sodium sulfate (Na₂SO₄), in consideration of the content of SO₃ contained in 20 g of the furnace slag. CO₂ gas was inputted into a closed reaction container having the mixture therein such that the partial pressure of CO₂ was 10 bar, and then the reaction was allowed to proceed at 290° C. for 6 hours while stirring was conducted at a rotational speed of 1500 rpm. The resultant material obtained after the foregoing hydrothermal reaction was filtered, and then subjected to several times of washing to remove residual salts, followed by drying at 90° C., thereby obtaining a product.

### Comparative Example 1

Comparative Example 1 was conducted by the same process as Example 1 except that NaOH was not added and CO₂ gas was inputted into a closed reaction container having the mixture therein such that the partial pressure of CO₂ was 5 bar.

### Comparative Example 2

Comparative Example 2 was conducted by the same process as Comparative Example 1 except that the reaction temperature was increased to 200° C.

### Comparative Example 3

Comparative Example 3 was conducted by the same process as Comparative Example 1 except that the reaction temperature was increased to 290° C.

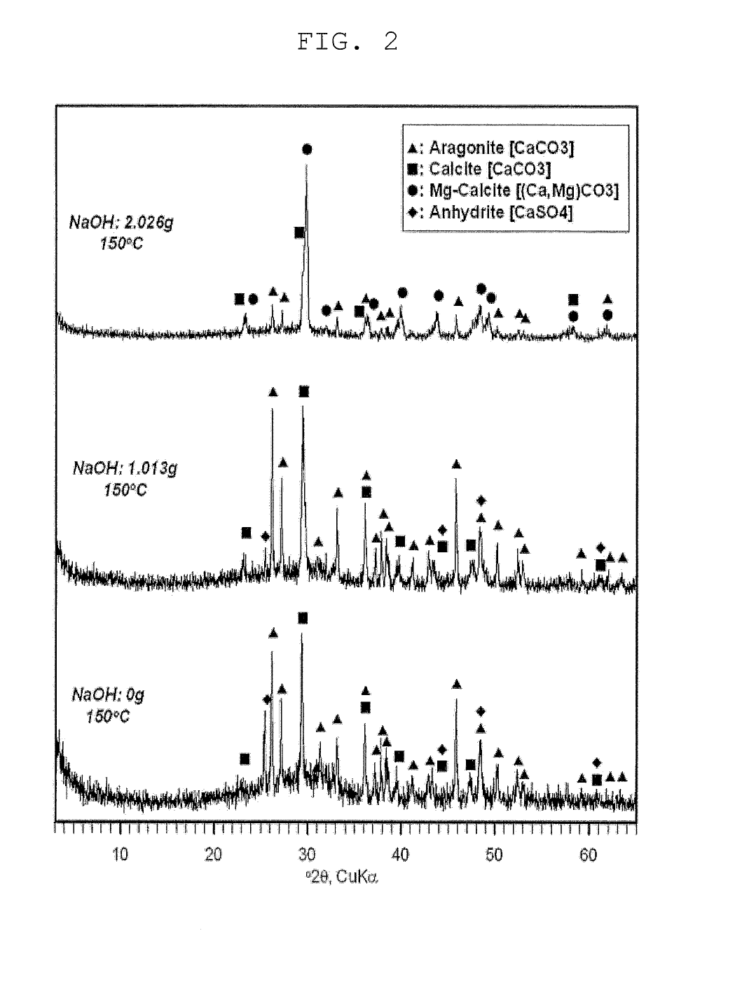

FIG. 2 shows XRD analysis results of Comparative Example 1 and Examples 1 and 2.

As the XRD analysis results of the resultant material obtained from the hydrothermal reaction, Comparative Example 1 showed that a significant amount of amorphous phase was generated and the content of CaSO₄ was decreased but the content of CaCO₃ was increased in proportion to an increase in the partial pressure of CO₂ and the amount of NaOH added. In addition, based on the XRD data, measurement results of contents of component minerals, which are obtained by using the SIROQUANT program with respect to the component minerals (crystalline minerals) exhibiting diffraction patterns, were shown in Table 2.

The contents of CaCO₃ were 43.95 wt. % and 52.26 wt. %, and then the carbonation rates of CaO were 75.20% and 89.42%, for Examples 1 and 2, which indicated significant increases of 1.6 times and 1.9 times more as compared with Comparative Example 1. These result values were shown in Table 2 below. Resultantly, it was indicated that, at the time of a mineral carbonation process, when the amount of NaOH added was increased, in particular, 2 g or more of NaOH per 20 g of the furnace slag was added, the carbonation rate of CaO was very efficacious.

TABLE 2

| | Solid | | | | | | | | | | |
|---|---|---|---|---|---|---|---|---|---|---|---|
| | liquid | | | | | | | | | Carbon | |
| | ratio (g | | | | | | | | | Analysis | |
| | of | | | | | | | | | Results | |
| | furnace | | | | Partial | XRD Quantitative Analysis | | | | | Carbonate |
| | slag per | | Reaction | Reaction | Pressure | (wt. %) | | | | Carbonate | of |
| | 100 g of | | Temperature | Time | of CO₂ | | | Mg- | | Mineral | CaO |
| | water) | NaOH g | (° C.) | (h) | (bar) | Anhydrite | Calcite | Calcite | Aragonite | (wt. %) | (%) |
| Comparative | 10 | 0 | 150 | 6 | 5 | 10.4 | 29.3 | 0 | 60.3 | 27.05 | 46.29 |
| Example 1 | | | | | | | | | | | |
| Example 1 | 10 | 1.013 | 150 | 6 | 10 | 3.6 | 29.3 | 0 | 67.1 | 43.95 | 75.20 |
| Example 2 | 10 | 2.026 | 150 | 6 | 10 | 0 | 23.6 | 53.3 | 23.1 | 52.26 | 89.42 |

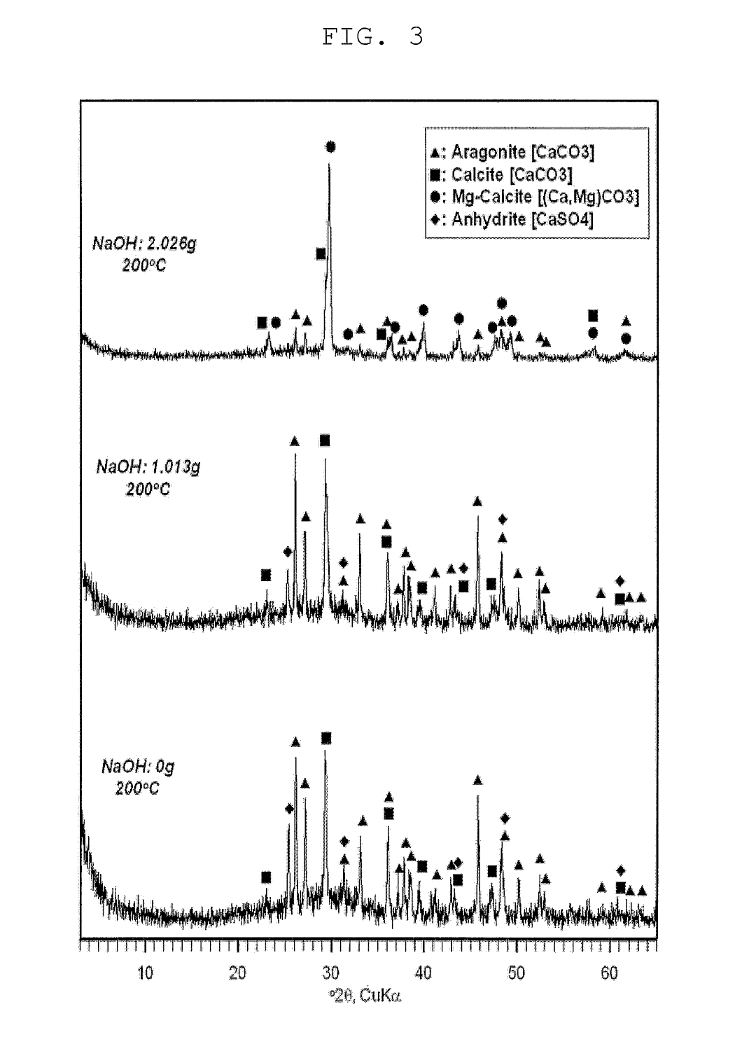

FIG. 3 shows XRD analysis results of Comparative Example 2 and Examples 3 and 4.

As the XRD analysis results of the resultant material obtained from the hydrothermal reaction, Comparative Example 2 showed that a significant amount of amorphous phase was generated, like Comparative Example 1, and the content of CaSO₄ was decreased but the content of CaCO₃ was increased in proportion to an increase in the partial pressure of CO₂ and the amount of NaOH added. In addition, the contents of crystalline phases and the content of CaO participating in the carbonation procedure, that is, the carbonation rate of CaO, were calculated by using the SIROQUANT program, and shown in Table 3 below.

The contents of CaCO₃ were 45.33 wt. % and 53.02 wt. %, and the carbonation rates of CaO were 77.56% and 90.72%, for Examples 3 and 4, which indicated significant increases of 1.5 times and 1.8 times more as compared with Comparative Example 2. These result values were shown in Table 3 below. Resultantly, it was indicated that, at the time of a mineral carbonation process, when the amount of NaOH added was increased, in particular, 2 g or more of NaOH per 20 g of the furnace slag was added, the carbonation rate of CaO was very efficacious.

TABLE 3

| | Solid | | | | | | | | | | |
|---|---|---|---|---|---|---|---|---|---|---|---|
| | liquid | | | | | | | | | | |
| | ratio (g | | | | | | | | | | |
| | of | | | | | | | | | Carbon Analysis | |
| | furnace | | | | Partial | XRD Quantitative Analysis | | | | Results | |
| | slag per | | Reaction | Reaction | Pressure | (wt. %) | | | | Carbonate | Carbonate |
| | 100 g of | | Temperature | Time | of CO₂ | | | Mg- | | Mineral | of CaO |
| | water) | NaOH g | (° C.) | (h) | (bar) | Anhydrite | Calcite | Calcite | Aragonite | (wt. %) | (%) |
| Comparative | 10 | 0 | 200 | 6 | 5 | 12.0 | 24.5 | 0 | 63.5 | 29.81 | 51.01 |
| Example 2 | | | | | | | | | | | |
| Example 3 | 10 | 1.013 | 200 | 6 | 5 | 7.4 | 25.8 | 0 | 66.8 | 45.33 | 77.55 |
| Example 4 | 10 | 2.026 | 200 | 6 | 10 | 0 | 26.8 | 57.9 | 15.4 | 53.02 | 90.72 |

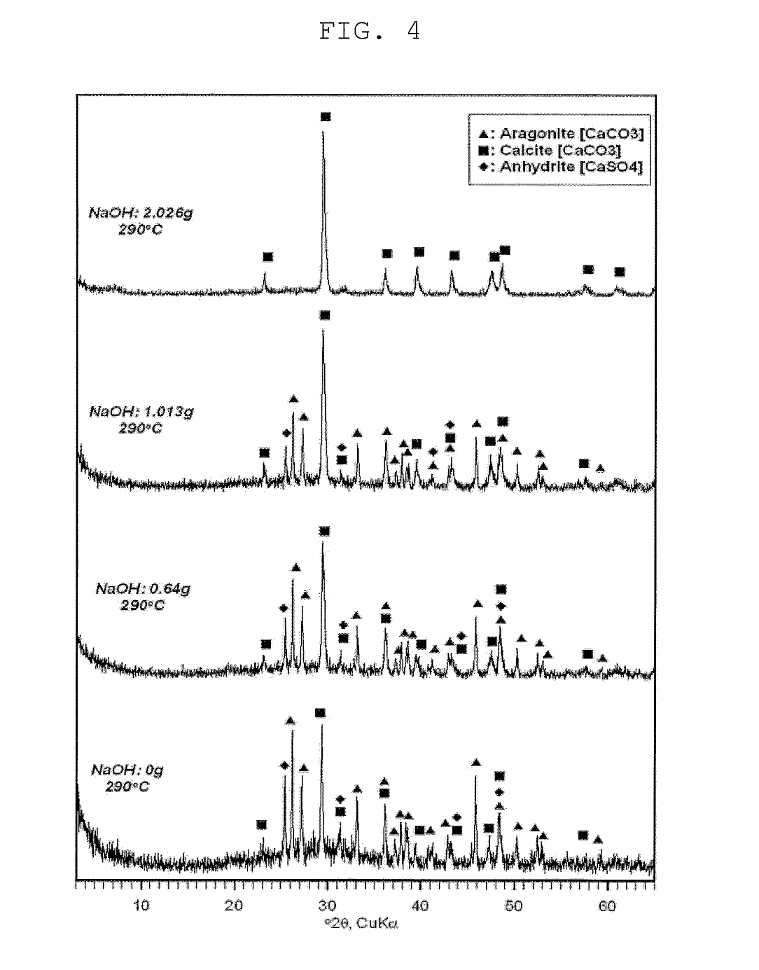

FIG. 4 shows XRD analysis results of Comparative Example 3 and Examples 5 to 7.

As the XRD analysis results of the resultant material obtained from the hydrothermal reaction, Comparative Example 3 showed that a significant amount of amorphous phase was generated, like Comparative Example 1, and the content of CaSO₄ was decreased but the content of CaCO₃ was increased in proportion to an increase in the partial pressure of CO₂ and the amount of NaOH added. In addition, the contents of crystalline phases and the content of CaO participating in the carbonation procedure, that is, the carbonation rate of CaO, were calculated by using the SIROQUANT program, and shown in Table 4 below.

The contents of CaCO₃ were 45.76 wt. o, 48.17 wt. o, and 52.16 wt. %, and the carbonation rates of CaO were 78.29%, 82.41%, and 89.24%, for Examples 5 to 7, which indicated significant increases of 1.5 times, 1.6 times, and 1.7 times more as compared with Comparative Example 3. These result values were shown in Table 4 below. Resultantly, it was indicated that, at the time of a mineral carbonation process, when the amount of NaOH added was increased, in particular, 2 g or more of NaOH per 20 g of the furnace slag was added, the carbonation rate of CaO was very efficacious.

TABLE 4

| | Solid | | | | | | | | | |
|---|---|---|---|---|---|---|---|---|---|---|
| | liquid | | | | | | | | | |
| | ratio (g | | | | | | | | | |
| | of | | | | | | | | Carbon Analysis | |
| | furnace | | | | Partial | | | | Results | |
| | slag per | | Reaction | Reaction | Pressure | XRD Quantitative | | | Carbonate | Carbonate |
| | 100 g of | | Temperature | Time | of CO₂ | Analysis (wt. %) | | | Mineral | of CaO |
| | water) | NaOH g | (° C.) | (h) | (bar) | Anhydrite | Calcite | Aragonite | (wt. %) | (%) |
| Comparative | 10 | 0 | 290 | 6 | 5 | 14.5 | 26.3 | 59.3 | 30.15 | 51.59 |
| Example 3 | | | | | | | | | | |
| Comparative | 10 | 0.64 | 290 | 6 | 10 | 9.3 | 34 | 56.7 | 45.76 | 78.29 |
| Example 5 | | | | | | | | | | |
| Example 6 | 10 | 1.013 | 290 | 6 | 10 | 7.5 | 41.8 | 50.6 | 48.17 | 82.41 |
| Example 7 | 10 | 2.026 | 290 | 6 | 10 | 0 | 100 | 0 | 52.16 | 89.24 |

As set forth above, the method for fixing carbon dioxide according to the present invention can fix carbon dioxide gas stably, and remarkably improve efficiency in carbonation of CaO contained in the furnace slag. Further, the treatment of the furnace slag can lead to ecofriendly effects and the use of the furnace slag can lead to production of carbonate minerals as the final product.

What is claimed is:

1. A method for fixing carbon dioxide, the method comprising:
a) pulverizing furnace slag (110);
b) mixing water and the furnace slag such that the furnace slag is present in a concentration of 5˜15 parts by weight based on 100 parts by weight of water (120);
c) adding NaOH to the mixture of the step b) (130); and
d) supplying carbon dioxide to the decomposed mixture of the step c), and then carrying out a hydrothermal reaction (140).

2. The method of claim 1, wherein in the step a), the furnace slag is pulverized into 150˜500 mesh.

3. The method of claim 1, wherein in the step c), NaOH is inputted in a weight ratio of 1 mol of SO₃: 2˜4 mol of NaOH so as to generate sodium sulfate (Na₂SO₄) or Burkeite (Na₆CO₃(SO₄)₂), which is a residual salt in the step d), to thereby suppress re-precipitation of anhydrite (CaSO₄) contained in the furnace slag even after the hydrothermal reaction.

4. The method of claim 3, further comprising, after the step d), e) removing the residual salt to improve grade of CaCO₃.

5. The method of claim 1, wherein in the step d), the carbon dioxide is supplied such that partial pressure of carbon dioxide within a reactor into which the mixture of the step c) is inputted becomes 10˜30 bar.

6. The method of claim 1, wherein the hydrothermal reaction of the step d) is conducted at 150˜300° C.

7. The method of claim 6, wherein the hydrothermal reaction of the step d) is conducted while stirring is performed at a rotational speed of 1200˜1700 rpm.

8. The method of claim 4, wherein in the step e), the removing of the residual salt is conducted by water washing.
